(19) United States
(12) Patent Application Publication
(10) Pub. No.: US 2011/0255840 A1
(43) Pub. Date: Oct. 20, 2011

(54) ADVERTISEMENTS THROUGH A DIGITAL VIDEO RECORDER (DVR)

(76) Inventor: Brett L. Bornsen, Thornton, CO (US)

(21) Appl. No.: 12/762,102

(22) Filed: Apr. 16, 2010

(51) Int. Cl. H04N 5/91

(52) U.S. Cl. 386/239; 386/E05.003

(57) ABSTRACT

System and methods are disclosed for displaying advertisements through a digital video recorder (DVR). In one embodiment, the DVR includes an advertisement storage system that stores advertisements from at least one third party advertiser. The DVR further includes an advertisement control system that detects activation of a fast forward feature during playing of a television program. In response to detecting the activation of the fast forward feature, the advertisement control system selects an advertisement from the advertisement storage system, and initiates the display of the selected advertisement in association with a progress bar that is displayed during activation of the fast forward feature.

### FIELD OF THE INVENTION

The invention relates to the field of digital video recorders (DVR), and more particularly, to providing advertisements through a DVR.

### BACKGROUND

A digital video recorder (DVR) is a device that records video in a digital format, and stores the video on a memory medium, such as a disk drive, a USB flash drive, etc. Most DVRs are set-top boxes that receive television signals from a source (content provider), and are able to record one or more television programs from the signals. The DVRs are also connected to televisions. When a viewer of a television selects a recorded program to watch, the DVR identifies the recorded program and plays it to the viewer over the television. While the program is being played, the viewer may fast forward through the program, rewind the program, pause the program, or perform some other feature.

One problem caused by DVRs is that a viewer can skip commercials that are part of the television program by using the fast forward feature. If enough viewers consistently skip commercials, then the advertisers may be motivated to reduce the amount of revenue they spent on commercials.

### SUMMARY

Embodiments provided herein describe systems and methods for advertising through a DVR. Most or all DVRs display some type of progress or control bar that indicates the current position in viewing a television program. In one embodiment, when a progress bar is displayed during a fast forward feature, an advertisement is selected and displayed in association with the progress bar. Thus, even though a viewer may be skipping commercials of the television program using the fast forward feature, an advertisement may still be provided to the viewer as part of the progress bar.

One embodiment comprises a digital video recorder (DVR) that includes an advertisement storage system operable to store advertisements from at least one third party advertiser. The DVR further includes an advertisement control system operable to detect activation of a fast forward feature during playing of a television program. In response to detecting the activation of the fast forward feature, the advertisement control system is further operable to select an advertisement from the advertisement storage system, and to initiate the display of the selected advertisement in association with a progress bar that is displayed during activation of the fast forward feature.

In another embodiment, the advertisement control system is operable to detect activation of a play feature for a television program. In response to detecting the activation of the play feature, the advertisement control system is further operable to select an advertisement from the advertisement storage system, and to initiate the display of the selected advertisement in association with a progress bar that is displayed during activation of the play feature.

In another embodiment, the advertisement control system is operable to detect activation of a pause feature during playing of a television program. In response to detecting the activation of the pause feature, the advertisement control system is further operable to select an advertisement from the advertisement storage system, and to initiate the display of the selected advertisement in association with a progress bar that is displayed during activation of the pause feature.

In another embodiment, the advertisement control system is operable to detect activation of a rewind feature during playing of a television program. In response to detecting the activation of the rewind feature, the advertisement control system is further operable to select an advertisement from the advertisement storage system, and to initiate the display of the selected advertisement in association with a progress bar that is displayed during activation of the rewind feature.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a digital video recorder (DVR).

FIG. 2 illustrates a progress bar displayed when a television program is played.

FIG. 3 illustrates a DVR in an exemplary embodiment.

FIG. 4 is a flow chart illustrating a method of displaying advertisements during activation of a fast forward feature in an exemplary embodiment.

FIG. 5 illustrates an advertisement displayed in association with a progress bar in an exemplary embodiment.

FIG. 6 illustrates an advertisement displayed in association with a progress bar in another exemplary embodiment.

FIG. 7 illustrates an advertisement displayed in association with a progress bar in another exemplary embodiment.

FIG. 8 is a flow chart illustrating a method of displaying advertisements during activation of a play feature in an exemplary embodiment.

FIG. 9 illustrates an advertisement displayed in association with a progress bar in an exemplary embodiment.

FIG. 10 is a flow chart illustrating a method of displaying advertisements during activation of a pause feature in an exemplary embodiment.

FIG. 11 illustrates an advertisement displayed in association with a progress bar in an exemplary embodiment.

FIG. 12 is a flow chart illustrating a method of displaying advertisements during activation of a rewind feature in an exemplary embodiment.

FIG. 13 illustrates an advertisement displayed in association with a progress bar in an exemplary embodiment.

### DESCRIPTION OF THE EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

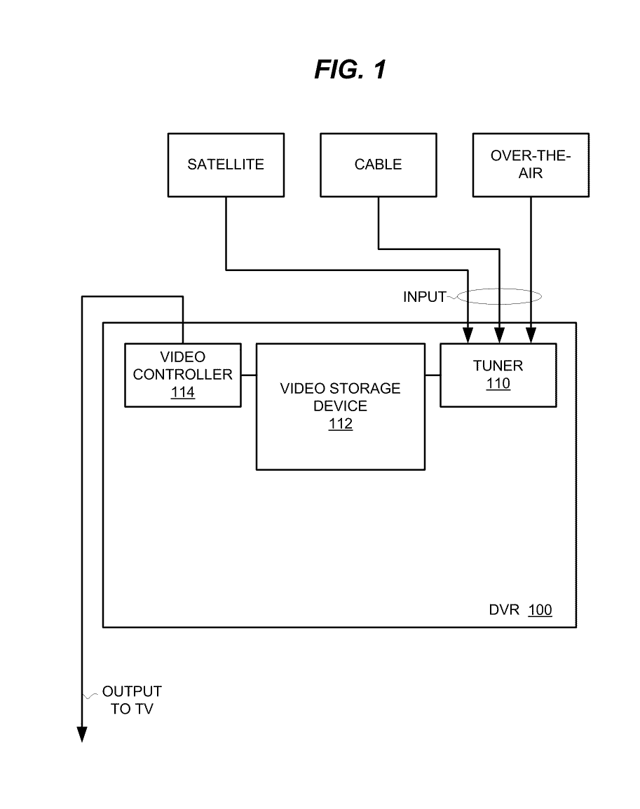

FIG. 1 illustrates a digital video recorder (DVR) 100. DVR 100 includes a tuner 110, a video storage device 112, and a video controller 114. Tuner 110 is operable to receive television signals from a variety of content providers (content sources). For example, a content provider may be a satellite provider, such as DirecTV, Inc, Dish Network Corporation, etc, which delivers television signals using communication satellites. A content provider may be a cable provider, such as Comcast Corporation, which delivers television signals using radio frequency signals transmitted through fixed optical fibers or coaxial cables. A content provider may also be an “over-the-air” provider, which broadcasts terrestrial television signals using radio waves for reception by an antenna or aerial. Video storage device 112 is operable to record or store television programs that are received via the television signals. Video storage device 112 may comprise a disk drive, a USB flash drive, an SD memory card, a solid-state memory, or some other memory medium. Video controller 114 is operable to control how television programs are provided to a television that is connected to DVR 100. Those skilled in the art will appreciate that DVRs may include other elements that are not shown in FIG. 1 for the sake of brevity.

When one or more television programs are stored in video storage device 112, video controller 114 allows a user to access and play a recorded television program. When the user first plays a television program, video controller 114 displays a progress bar (also referred to as a control bar) on the television over top of the television program. The progress bar indicates the current position in viewing the television program. For example, if the viewing starts at the beginning of the television program, then the progress bar indicates that current position in viewing the program is at the beginning. If the viewing starts in the middle of the television program, then the progress bar indicates that current position in viewing the program is in the middle. The progress bar may also indicate the length of the television program (e.g., 1 hour). While viewing the television program, video controller 114 may allow the view to pause the television program, fast forward through the television program, rewind the television program, or perform other features.

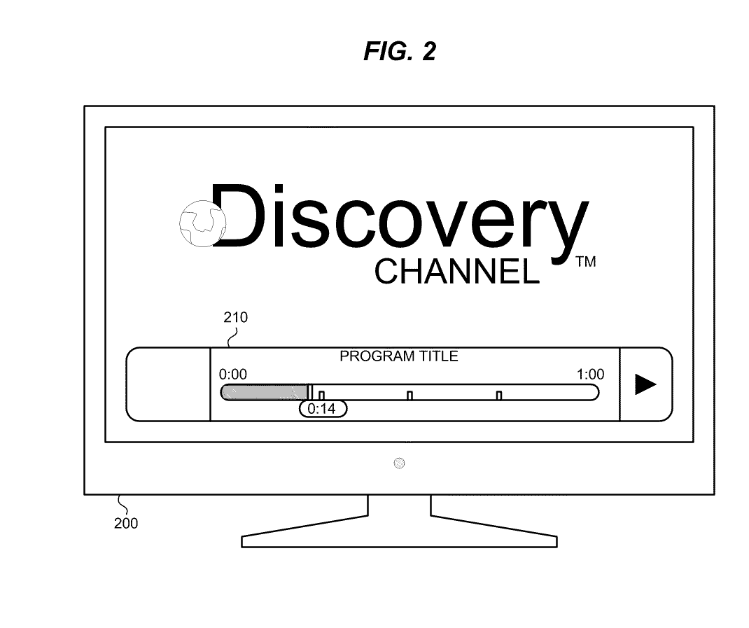

FIG. 2 illustrates a progress bar 210 displayed when a television program is played. DVR 100 in FIG. 1 is connected to television 200 in FIG. 2. When playing a recorded television program, DVR 100 displays progress bar 210 over top of the recorded television program, which is a Discovery Channel program as shown in FIG. 2. In this example, progress bar 210 shows a title of the television program and the length of the television program. Progress bar 210 also indicates the current position in viewing the television program, which is the 14 minute mark in this example. Similar progress bars are displayed when a fast forward feature, a rewind feature, a pause feature, etc, are activated by the viewer.

The embodiments described herein expand on the use of the progress bar to include advertisements from third party advertisers. Presently, progress bars do not display advertisements of third parties. The progress bars may display the title of the present program being viewed, and may display the name of the content provider that is supplying the television program. The following embodiments describe how advertisements are provided through the progress bar.

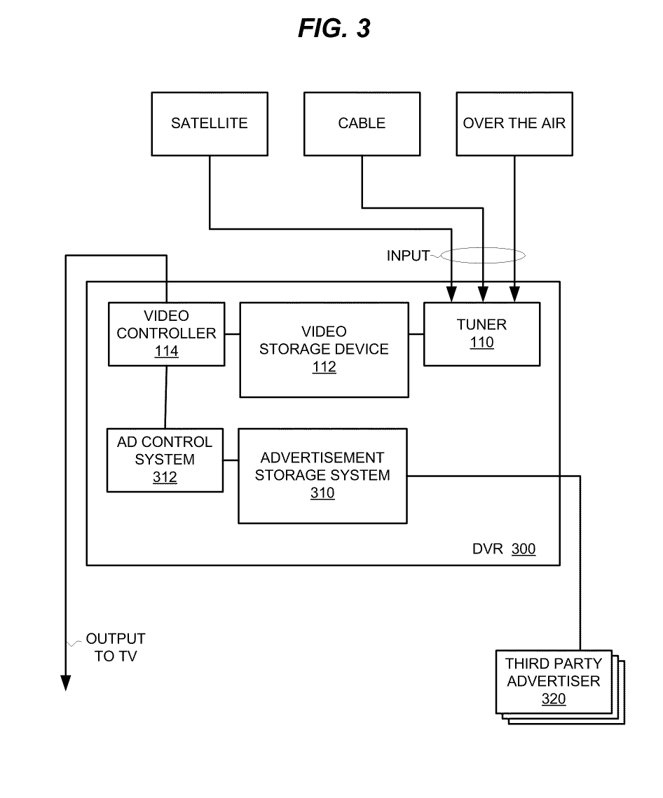

FIG. 3 illustrates a DVR 300 in an exemplary embodiment. In addition to the systems described in FIG. 1, DVR 300 further includes an advertisement storage system 310 and an advertisement control system 312. Advertisement storage system 310 comprises any device, component, or function operable to store advertisements for third party advertisers 320. Some examples of advertisement storage system 310 include a disk drive, a USB flash drive, an SD memory card, a solid-state memory, or some other memory medium. Advertisement storage system 310 may be a stand alone memory, or may be integrated with video storage device 112. For example, if video storage device 112 comprises a disk drive, then advertisement storage system 310 may be implemented on the same disk drive as video storage device 112.

Advertisement control system 312 comprises any device, component, or function operable to determine which advertisements are to be displayed in association with a progress bar. Advertisement control system 312 may be a stand alone device, or may be implemented on the same platform as video controller 114. For example, advertisement control system 312 may be implemented through a software upgrade to video controller 114.

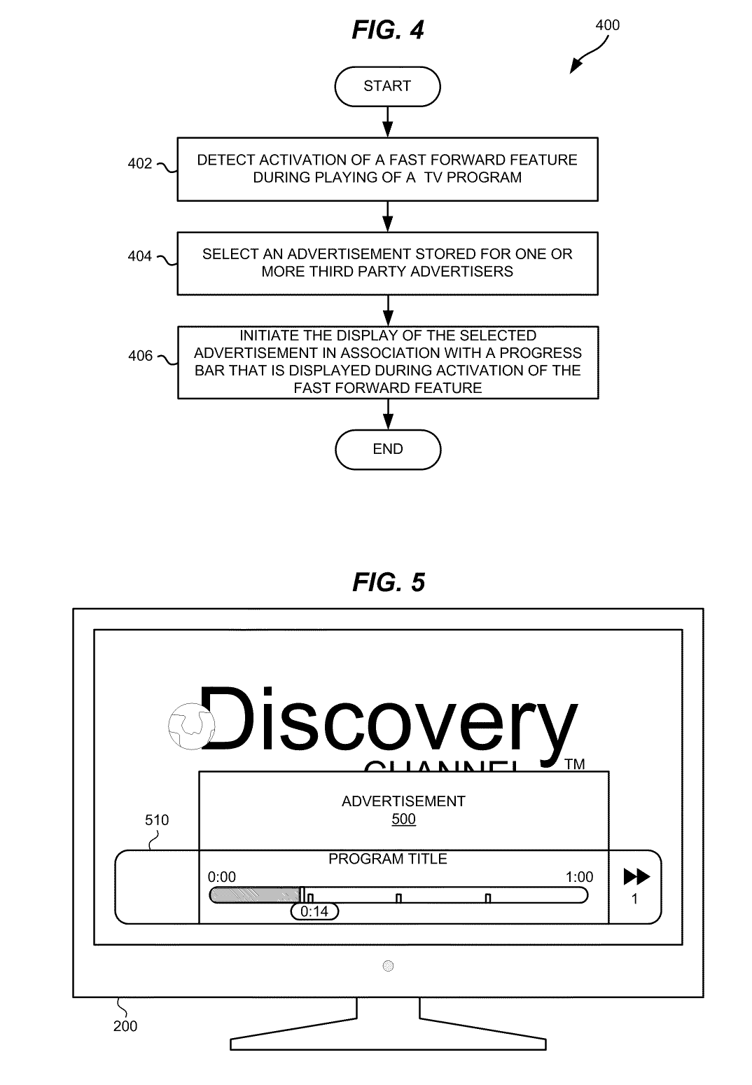

When in operation, advertisement storage system 310 receives a plurality of advertisements from third party advertisers 320. Third party advertisers 320 represent entities that contract with a content provider or DVR manufacturer for the purpose of advertising. The third party advertisers 320 do not represent the content providers or the DVR manufacturers themselves. The advertisements may be provided to DVR 300 in any desired manner. In one embodiment, advertisement storage system 310 may pull the advertisements from a server or servers that are operated by the third party advertisers 320, from the content provider, or from another party. For example, DVR 300 may contact the servers periodically through an internet or phone connection to retrieve the latest advertisements. In another embodiment, third party advertisers 320, the content provider, or another party may push the advertisements to advertisement storage system 310. For example, the content provider may push the advertisements to DVR 300 over a downstream link of the satellite signals. Advertisement storage system 310 then stores the advertisements from the third party advertisers. With the advertisements stored, DVR 300 is able to display one or more of the advertisements in association with a progress bar, which is further described in FIG. 4.

FIG. 4 is a flow chart illustrating a method 400 of displaying advertisements during activation of a fast forward feature in an exemplary embodiment. The steps of method 400 will be described with reference to DVR 300 in FIG. 3, although method 400 may be performed in other systems. The steps of the flow charts described herein are not all inclusive and may include other steps not shown. The steps may also be performed in an alternative order.

In step 402, advertisement control system 312 detects activation of a fast forward feature during playing of a television program. For example, advertisement control system 312 may detect a signal from a remote control or other user interface that activations the fast forward feature. In another example, advertisement control system 312 may receive a control signal from video controller 114 indicating that the fast forward feature has been activated.

In response to detecting the activation of the fast forward feature, advertisement control system 312 selects an advertisement from advertisement storage system 310 in step 404. Advertisement control system 312 may select the advertisement in a variety of ways. In one embodiment, advertisement control system 312 may select the advertisement based on one or more tags inserted in metadata of the television program. In another embodiment, advertisement control system 312 may select the advertisement based on information about a viewer of the television program. For example, advertisement control system 312 may store information on programs commonly watched by the viewer, such as sporting events. Advertisement control system 312 can then use this information to select an advertisement that is tailored towards the preferences of the viewer.

In another embodiment, assume that the television program includes a commercial that was skipped via the fast forward feature. Advertisement control system 312 may select the advertisement based on the commercial that was skipped. For example, if the commercial skipped was for a brand of soda, advertisement control system 312 may select an advertisement that relates to that same brand of soda. In another embodiment, advertisement control system 312 may select the advertisement based on subject matter of the television program. For example, if the television program is a sporting event, then advertisement control system 312 may select an advertisement that relates to sports. Advertisement control system 312 may select the advertisements in other ways, such as randomly, based on how much the third party advertiser 320 paid for the advertisement, time of day, etc.

In step 406, advertisement control system 312 initiates the display of the selected advertisement in association with a progress bar that is displayed during activation of the fast forward feature. Displaying the selected advertisements “in association” with a progress bar means that when the progress bar is displayed due to activation of a feature, the selected advertisement is also displayed. The selected advertisement may be displayed proximate to the progress bar, in the progress bar, or in another location. However, the initial display of the advertisement is triggered by the display of the progress bar. When the progress bar is no longer displayed, the associated advertisement should likewise be removed from the screen. However, it may be the case where the selected advertisement remains displayed for a time period after the progress bar is removed from the screen.

FIG. 5 illustrates an advertisement 500 displayed in association with a progress bar 510 in an exemplary embodiment. When the fast forward feature is activated, DVR 300 displays a progress bar 510 over top of the recorded television program. In this embodiment, advertisement 500 is also displayed with progress bar 510. Thus, a third party advertiser 320 is able to provide an advertisement 500 to a viewer of television 200 while he/she is fast forwarding through the television program. Even if the viewer is fast forwarding through commercials, a third party advertiser 320 is still able to provide advertising to the viewer, which creates a new revenue source for the content provide or DVR manufacturer.

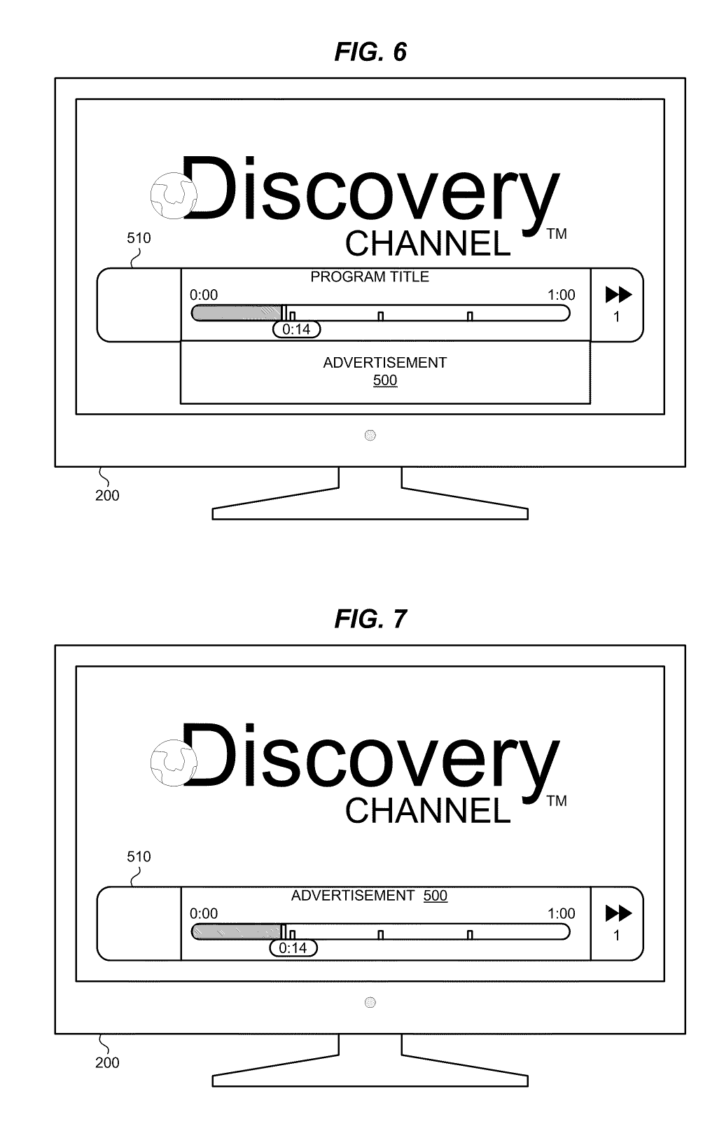

The advertisement 500 may be displayed in a variety of positions relative to the progress bar 510. In FIG. 5, the advertisement 500 is displayed above the progress bar 510. In other embodiments, the advertisement 500 may be displayed below the progress bar 510 as in FIG. 6. In yet another embodiment, the advertisement 500 is displayed in the progress bar 510 in place of the program title as in FIG. 7. There may be multiple other options for displaying the advertisement 500 in association with the progress bar 510.

Depending on how long the progress bar 510 is displayed for the fast forward feature, advertisement control system 312 may select multiple advertisements. Many of the fast forward features allow a viewer to select how fast the television program advances in time. For example, a fast forward feature may have a “1” setting for a slow advance, a “2” setting for a faster advance, a “3” setting for yet a faster advance, and a “4” setting for the fastest advance. Assume that a viewer is fast forwarding through commercials of a television program. If the viewer selects a “1” or “2” as the setting, it may take 20 seconds, 40 seconds, 90 seconds, etc, to fast forward through the commercials. Depending on the setting selected by the viewer, advertisement control system 312 may have time to display multiple advertisements along with the progress bar 510.

Because DVR 300 provides other features that cause the display of a progress bar, advertisements may be displayed when these other features are activated. The following FIGS illustrate displaying an advertisement when other features are activated.

FIG. 8 is a flow chart illustrating a method 800 of displaying advertisements during activation of a play feature in an exemplary embodiment. In step 802, advertisement control system 312 detects activation of a play feature for a television program. In response to detecting the activation of the play feature, advertisement control system 312 selects an advertisement from advertisement storage system 310 in step 804. In step 806, advertisement control system 312 initiates the display of the selected advertisement in association with a progress bar that is displayed during activation of the play feature.

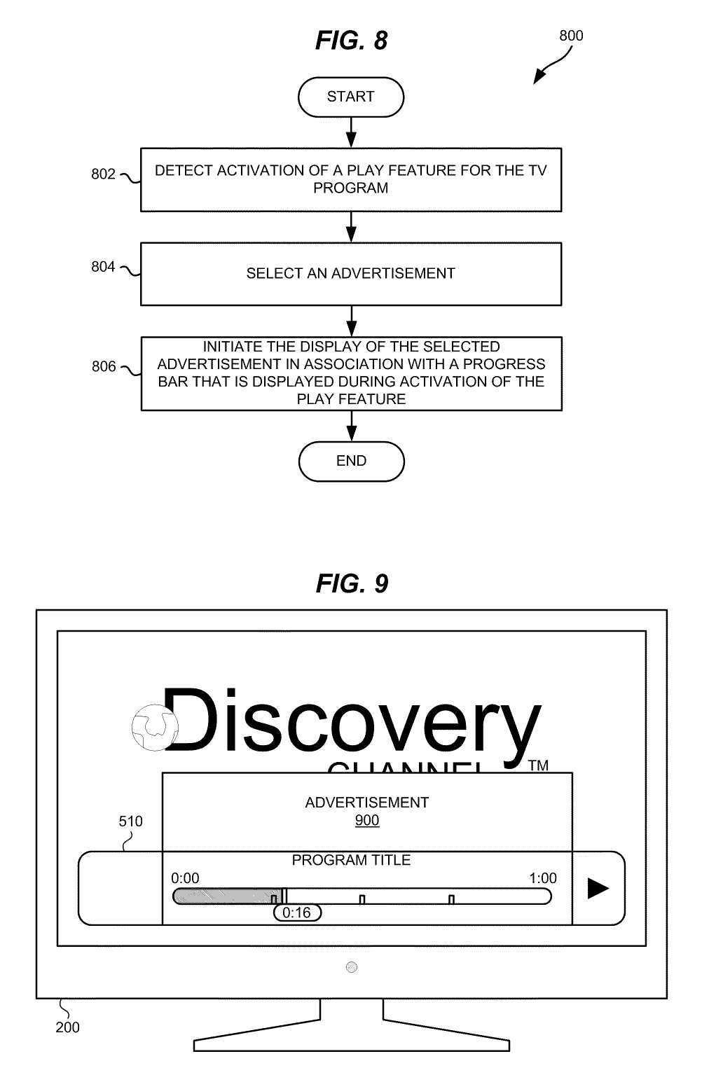

FIG. 9 illustrates an advertisement 900 displayed in association with a progress bar 510 in an exemplary embodiment. When the play feature is activated, DVR 300 displays a progress bar 510 over top of the recorded television program. In this embodiment, advertisement 900 is also displayed with progress bar 510. Thus, a third party advertiser 320 is able to provide an advertisement 900 to a viewer of television 200 when he/she hits play for the television program.

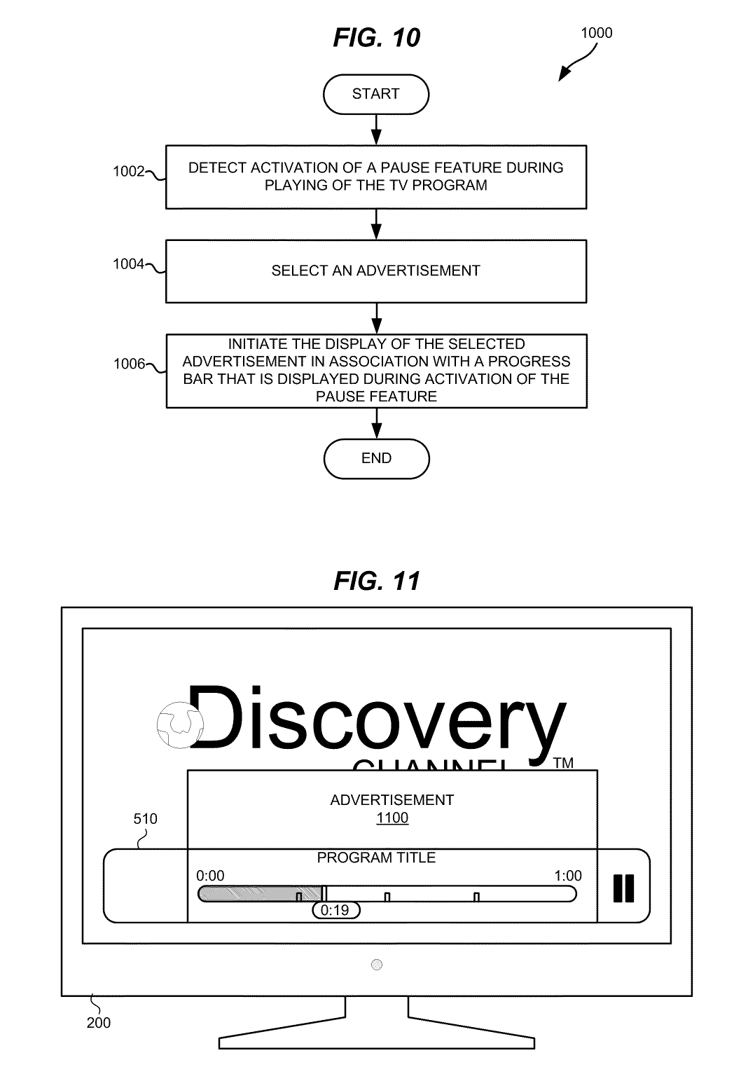

FIG. 10 is a flow chart illustrating a method 1000 of displaying advertisements during activation of a pause feature in an exemplary embodiment. In step 1002, advertisement control system 312 detects activation of a pause feature during playing of a television program. In response to detecting the activation of the pause feature, advertisement control system 312 selects an advertisement from advertisement storage system 310 in step 1004. In step 1006, advertisement control system 312 initiates the display of the selected advertisement in association with a progress bar that is displayed during activation of the pause feature.

FIG. 11 illustrates an advertisement 1100 displayed in association with a progress bar 510 in an exemplary embodiment. When the pause feature is activated, DVR 300 displays progress bar 510 and advertisement 1100. Thus, a third party advertiser 320 is able to provide an advertisement 1100 to a viewer of television 200 when he/she pauses the television program.

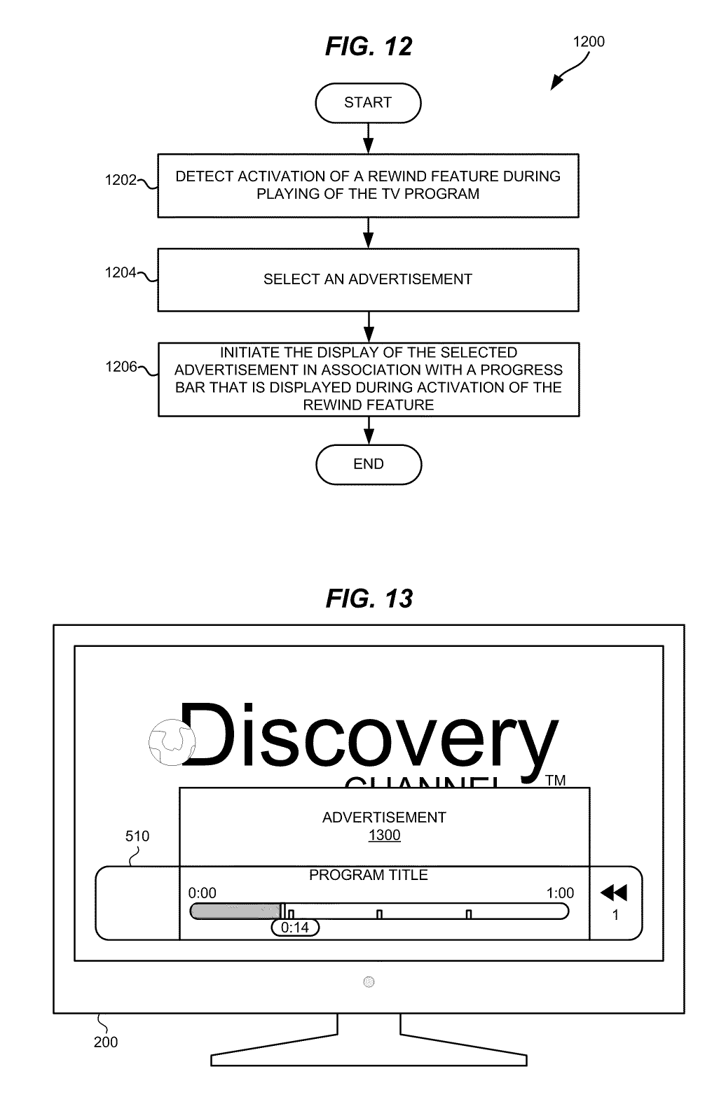

FIG. 12 is a flow chart illustrating a method 1200 of displaying advertisements during activation of a rewind feature in an exemplary embodiment. In step 1202, advertisement control system 312 detects activation of a rewind feature during playing of a television program. In response to detecting the activation of the rewind feature, advertisement control system 312 selects an advertisement from advertisement storage system 310 in step 1204. In step 1206, advertisement control system 312 initiates the display of the selected advertisement in association with a progress bar that is displayed during activation of the rewind feature.

FIG. 13 illustrates an advertisement 1300 displayed in association with a progress bar 510 in an exemplary embodiment. When the rewind feature is activated, DVR 300 displays progress bar 510 and advertisement 1300. Thus, a third party advertiser 320 is able to provide an advertisement 1300 to a viewer of television 200 when he/she rewinds the television program.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

I claim:

1. A digital video recorder, comprising:
an advertisement storage system operable to store advertisements from at least one third party advertiser; and
an advertisement control system operable to detect activation of a fast forward feature during playing of a television program, to select an advertisement from the advertisement storage system responsive to detecting the activation of the fast forward feature, and to initiate the display of the selected advertisement in association with a progress bar that is displayed during activation of the fast forward feature.

2. The digital video recorder of claim 1 wherein:
the advertisement control system is further operable to select the advertisement based on a tag inserted in metadata of the television program.

3. The digital video recorder of claim 1 wherein:
the advertisement control system is further operable to select the advertisement based on information about a viewer of the television program.

4. The digital video recorder of claim 1 wherein:
the television program includes a commercial that was skipped via the fast forward feature; and
the advertisement control system is further operable to select the advertisement based on the commercial that was skipped.

5. The digital video recorder of claim 1 wherein:
the advertisement control system is further operable to select the advertisement based on subject matter of the television program.

6. The digital video recorder of claim 1 wherein:
the advertisement control system is further operable to detect activation of a play feature for the television program, to select another advertisement from the advertisement storage system responsive to detecting the activation of the play feature, and to initiate the display of the selected other advertisement in association with a progress bar that is displayed during activation of the play feature.

7. The digital video recorder of claim 1 wherein:
the advertisement control system is further operable to detect activation of a pause feature during playing of the television program, to select another advertisement from the advertisement storage system responsive to detecting the activation of the pause feature, and to initiate the display of the selected other advertisement in association with a progress bar that is displayed during activation of the pause feature.

8. The digital video recorder of claim 1 wherein:
the advertisement control system is further operable to detect activation of a rewind feature during playing of the television program, to select another advertisement from the advertisement storage system responsive to detecting the activation of the rewind feature, and to initiate the display of the selected other advertisement in association with a progress bar that is displayed during activation of the rewind feature.

9. A method of displaying advertisements through a digital video recorder, the method comprising:
detecting activation of a fast forward feature during playing of a television program;
selecting an advertisement responsive to detecting the activation of the fast forward feature; and
initiating the display of the selected advertisement in association with a progress bar that is displayed during activation of the fast forward feature.

10. The method of claim 9 wherein selecting an advertisement comprises:
selecting the advertisement based on a tag inserted in metadata of the television program.

11. The method of claim 9 wherein selecting an advertisement comprises:
selecting the advertisement based on information about a viewer of the television program.

12. The method of claim 9 wherein:
the television program includes a commercial that was skipped via the fast forward feature; and
selecting an advertisement comprises selecting the advertisement based on the commercial that was skipped.

13. The method of claim 9 wherein selecting an advertisement comprises:
selecting the advertisement based on subject matter of the television program.

14. The method of claim 9 further comprising:
detecting activation of a play feature for the television program;
selecting another advertisement responsive to detecting the activation of the play feature; and
initiating the display of the selected other advertisement in association with a progress bar that is displayed during activation of the play feature.

15. The method of claim 9 further comprising:
detecting activation of a pause feature during playing of the television program;
selecting another advertisement responsive to detecting the activation of the pause feature; and
initiating the display of the selected other advertisement in association with a progress bar that is displayed during activation of the pause feature.

16. The method of claim 9 further comprising:
detecting activation of a rewind feature during playing of the television program;
selecting another advertisement responsive to detecting the activation of the rewind feature; and
initiating the display of the selected other advertisement in association with a progress bar that is displayed during activation of the rewind feature.

17. A computer readable medium tangibly embodying programmed instructions which, when executed by a computer system, are operable to perform a method of displaying advertisements through a digital video recorder (DVR), the method comprising:
detecting activation of a fast forward feature during playing of a television program;
selecting an advertisement responsive to detecting the activation of the fast forward feature; and
initiating the display of the selected advertisement in association with a progress bar that is displayed during activation of the fast forward feature.

18. The computer readable medium of claim 17 further comprising:
detecting activation of a play feature for the television program;
selecting another advertisement responsive to detecting the activation of the play feature; and
initiating the display of the selected other advertisement in association with a progress bar that is displayed during activation of the play feature.

19. The computer readable medium of claim 17 further comprising:
detecting activation of a pause feature during playing of the television program;
selecting another advertisement responsive to detecting the activation of the pause feature; and
initiating the display of the selected other advertisement in association with a progress bar that is displayed during activation of the pause feature.

20. The computer readable medium of claim 17 further comprising:
detecting activation of a rewind feature during playing of the television program;
selecting another advertisement responsive to detecting the activation of the rewind feature; and
initiating the display of the selected other advertisement in association with a progress bar that is displayed during activation of the rewind feature.
